(19) United States
(12) Patent Application Publication
(10) Pub. No.: US 2022/0227591 A1
(43) Pub. Date: Jul. 21, 2022

(54) Printer Paper Tray Easy-Swap Paper Lift

(71) Applicant: Charles Dulin, Tigard, OR (US)

(72) Inventor: Charles Dulin, Tigard, OR (US)

(21) Appl. No.: 17/154,813

(22) Filed: Jan. 21, 2021

(51) Int. Cl. B65H 1/30; B41J 13/10; B65H 1/12

(52) U.S. Cl. CPC B65H 1/30; B65H 1/12; B41J 13/10

(57) ABSTRACT

An article of manufacture for providing a printer paper tray easy-swap paper lift is disclosed. The easy swap paper lift includes a pair of side edges configured to slide with the pair of guide slots are cut into the opposing inner side walls of the paper tray, a rigid surface coupled to the pair of guide slots extending outward to engage under an outer end of a stack of paper within the paper tray, and a pair of lift tabs coupled to a top surface of the pair of guide slots extending outward from the opposing side walls of the paper tray, the pair of lift tabs raise the stack of paper.

### TECHNICAL FIELD

This application relates in general to an article of manufacture for providing computer printing aids, and more specifically, to an article of manufacture for a printer paper tray easy swap paper lift.

### BACKGROUND

After placing paper into the paper tray of a printer and/or photocopier you may need to remove it to place a different size of paper or style of form into the tray. For instance, a user may have blank checks in the tray when paying bills but then need to remove the checks to secure them or to place regular blank paper in the tray. Current copier/printer trays do not have anything that helps get the paper out. Users must dig in with fingers or some impromptu tool to get under the stack to lift it out. This can be a safety issue as well as an issue of accessibility.

Therefore, a need exists for an article of manufacture for providing a printer paper tray easy swap paper lift. The present invention attempts to address the limitations and deficiencies in prior solutions according to the principles and example embodiments disclosed herein.

### SUMMARY

In accordance with the present invention, the above and other problems are solved by providing an article of manufacture for a printer paper tray easy swap paper lift to the principles and example embodiments disclosed herein.

In one embodiment, the present invention is an article of manufacture for providing a printer paper tray easy swap paper lift. The easy swap paper lift includes a pair of side edges configured to slide with the pair of guide slots are cut into the opposing inner side walls of the paper tray, a rigid surface coupled to the pair of guide slots extending outward to engage under an outer end of a stack of paper within the paper tray, and a pair of lift tabs coupled to a top surface of the pair of guide slots extending outward from the opposing side walls of the paper tray, the pair of lift tabs raise the stack of paper.

In another aspect of the present disclosure, the easy swap paper lift further includes a lifting spring coupled to a bottom surface of the rigid surface to force the rigid surface upward exposing the stack of paper within the paper for removal.

In another aspect of the present disclosure, one of the pair of lift tabs engage a restraining clip coupled to one of the side walls for restraining the easy swap paper lift in a lowered position.

In another aspect of the present disclosure, the easy swap paper lift further comprises a plurality of lifting springs coupled to a bottom surface of the rigid surface.

In another aspect of the present disclosure, the easy swap paper lift further includes a restraining spring coupled to a front edge of the rigid surface and a bottom surface of the paper tray to force the rigid surface downward when the lift tabs are not lifted upward to exposing the stack of paper within the paper for removal.

In another aspect of the present disclosure, the rigid surface pivots about the connection with the pair of side edges as the rear edge of the rigid surface moves up and down as the pair of side edges slide up and down within the pair of guide slots.

In another aspect of the present disclosure, the front edge of the rigid surface comprises a pair of sliding tabs on opposing sides of the rigid surface that engage sliding guide slots within the bottom surface of the paper tray.

In another aspect of the present disclosure, the rigid surface extends under the stack of paper perpendicular to the pair of guide slots.

In another aspect of the present disclosure, the easy swap paper lift engages legal size printer paper.

In another aspect of the present disclosure, the easy swap paper lift engages letter size printer paper.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example computing system using an article of manufacture providing a printer paper tray easy swap paper lift according to the present invention.

FIG. 2 illustrates an example embodiment of an article of manufacture providing a printer paper tray easy swap paper lift according to the present invention.

FIG. 3 illustrates a top perspective view of an article of manufacture for providing a printer paper tray easy swap paper lift according to the present invention.

FIGS. 4a-b illustrate a side view of support elements that are part of an article of manufacture for providing a printer paper tray easy swap paper lift according to the present invention.

### DETAILED DESCRIPTION

This application relates in general to an article of manufacture for computer printing aids, and more specifically, to an article of manufacture for providing a printer paper tray easy swap paper lift according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “printer” and “user” refer to an entity, e.g. a human, using a printer paper tray easy swap paper lift associated with the invention. The term user herein refers to one or more users.

The term “invention” or “present invention” refers to the invention being applied for via the patent application with the title “Printer Paper Tray Easy-Swap Lift.” Invention may be used interchangeably with paper lift.

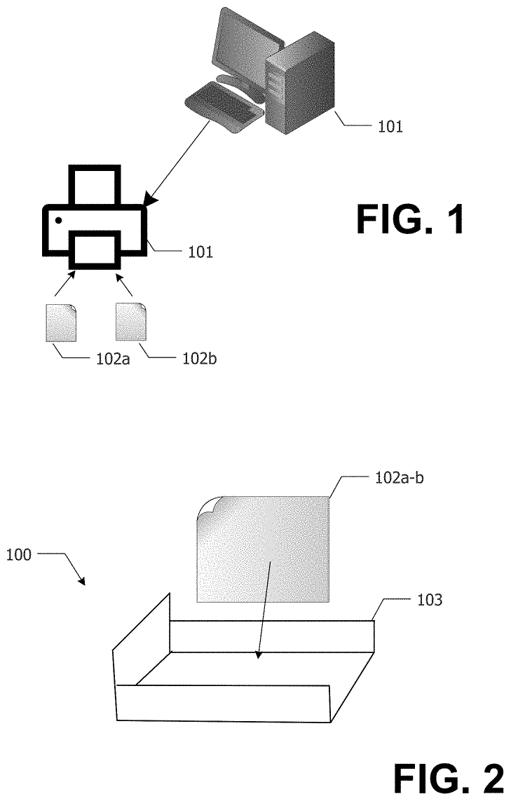

In general, the present disclosure relates to an article of manufacture for providing computer printing aids. To better understand the present invention, FIG. 1 illustrates an example computing system using an article of manufacture for a printer paper tray easy swap paper lift according to the present invention. Users of computers 101 use printers 101 to generate output of all types. The printers 102 may print on different types of paper 110a-b such as letterhead, plain paper, and checks, legal sized, and letter sized papers among others. Many printers do not support enough different paper trays even if more than one is present. As such, users must stop what they are doing to remove one type of paper 110a and replace it with another type of paper 110b before a print job may be completed.

Many users find it difficult to get all of the sheets of paper of one type out of the tray in order to insert a different paper 110b. Use of an inexpensive paper lift 201 that holds each type of paper 110a-b that may be inserted and removed from the paper tray of the printer 102 eliminates this difficulty that users experience.

FIG. 2 illustrates an example embodiment of an article of manufacture providing a printer paper tray easy swap paper lift according to the present invention. A stiff piece of plastic or metal may sit under the paper and has tabs at the top sides of the drawer. By lifting with the tabs, users lift the end of the paper stack until it is clear of the paper tray sides, enabling users to easily grasp the stack for removal. Alternately, a piece of the tray floor could be used. This additional piece of material could be connected to the rest of the tray floor with a hinge (not shown) and have the tabs connected to the top sides that would lift the movable portion of the tray floor enabling a person to easily grasp the stack of paper.

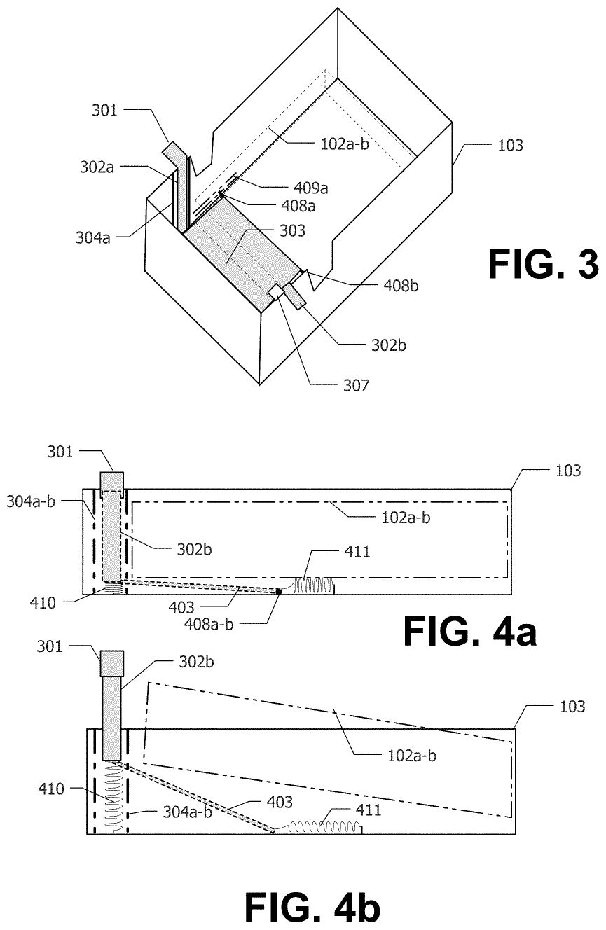

FIG. 3 illustrates a top perspective view of an article of manufacture for providing a printer paper tray easy swap paper lift according to the present invention. The paper lift 301 includes a bottom surface 303, a pair of side edges 302a-b having lift tabs 305a-b on each side to raise a stack of paper 110a-b with the paper lift 301. A pair of guide slots 304a-b are cut into the inner side walls of the paper tray 103. The each of the pair of side edges 302a-b slide within a corresponding guide slot 304a-b.

The present invention may also be implemented as a spring-loaded and hinged portion of the bottom of the tray 103. When paper 110a-b is placed in the tray 103 and pushed down, a restraining catch can hold the bottom surface 303 down. A button at the top side of the tray would release the catch allowing the spring to lift the hinged portion of the floor to an angle that makes the paper easily grasped for removal. One or more spring(s) lifting springs 410 may be located under the bottom of the rigid surface 303, but in the guide slots 304a-b may balance the weight of the paper 102a-b better to lift the paper evenly, so it could be either.

FIGS. 4a-b illustrate a side views of support elements that are part of an article of manufacture for providing a printer paper tray easy swap paper lift according to the present invention. FIG. 4a shows the paper lift 301 in a retracted position in which the bottom surface 303 is flush against the bottom of the tray 103 and the side edges 302a-b are pressed down into the guide slots 304a-b. The lift tabs 305a-b extend outward from the paper tray 103.The paper tray 103 is shown with a stack of paper 110a-b within the paper lift 301 and between the side edges 302a-b. The bottom surface 303 of the paper lift 301 is placed under the stack of paper 110a-b. As the pair of side edges 302a-b rise, the underside of the rigid surface 303 lifts the stack of paper 110a-b to allow it to be changed from one type of paper to another type of paper. In this embodiment shown in FIG. 4a, the bottom surface is a rigid surface 303 extending outward from the pair of side edges 302a-b that engages one end of the stack of paper 110a-b causing it to rise.

FIG. 4b shows the paper tray 103 and paper lift 301 of FIG. 4a in which the paper lift 301 has been raised upward. A user may lift the paper lift 301 upward by holding and lifting one or both of the lift tabs 305a-b. The pair of side edges 302a-b are also lifted upward in the guide slots 304a-b as the lift tabs 305a-bare raised. As the pair of side edges 302a-b rise, the bottom surface 303 lifts the stack of paper 110a-b to allow it to be changed from one type of paper to another type of paper. In this alternate embodiment shown in FIG. 4b, the bottom surface 303 may be hinged at a point where it is coupled to the bottom of the pair of side edges 302a-b. An opposite end of the bottom surface 303 engages with the bottom surface of the paper tray 103 causing the bottom surface to pivot one end rises.

A lifting spring 410 or a restraining spring 411 may be used to assist in moving the paper lift 301. The lifting spring 410 may be coupled to a bottom surface 303 of the paper lift 301. The lift tabs 305a-b may engage a restraining tab 307 to hold the lift tabs 305a-b down in a depressed position as shown in FIG. 4a. When the lift tabs 305a-b disengages the restraining tab, the lifting spring 410 pushes the paper lift 301 upward from the bottom of the paper tray 103 causing the paper 102a-b to be raised providing a user access to remove and swap a type of paper 102a-b.

In another embodiment, a restraining spring 411 is coupled to a front edge of the rigid surface 303 of the paper lift 301 and a bottom of the paper tray 412. When the lift tabs 305a-b is lifted by a user that pulls up on a rear edge of the rigid surface 303 to list the paper 102a-b. When the rear edge of the rigid surface 303 is pulled upward, the front edge of the rigid surface is moved rearward against the restraining spring 411 and the rigid surface 303 pivots about the connection with the pair of side edges as the rear edge of the rigid surface moves up and down as the pair of side edges 302a-b slide up and down within the pair of guide slots 304a-b. The front edge of the rigid surface 303 has a pair of sliding tabs 408a-b on opposing sides of the rigid surface that engage sliding guide slots 409a-b within the bottom surface of the paper tray 103.

When the user releases the lift tabs 305a-b, the restraining spring 411 pulls the front edge of the rigid surface 303 forward causing the rear edge of the rigid surface 303, the side edges 302a-b, and the lifting tabs 305a-b downward, thus allowing the paper 102a-b to return to be within the paper tray 103. The alternate embodiment limits in paper lift's 301 movement so the user can complete lifting the paper ends upwards with the paper lift 301 to facilitate the paper removal.

In an alternate embodiment, the present invention may be implemented as a lever type of action that would accomplish the same goal of lifting the end of the paper stack above the sides of the paper tray making it easy to grasp and remove the paper stack. This might need a spring assist to make it easier to lift heavier stacks.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture for providing an easy swap paper lift within a printer paper tray, the printer paper tray having a pair of guide slots are cut into opposing inner side walls of the paper tray, the easy swap paper lift comprises:
a pair of side edges configured to slide with the pair of guide slots are cut into the opposing inner side walls of the paper tray;
a rigid surface coupled to the pair of guide slots extending outward to engage under an outer end of a stack of paper within the paper tray; and
a pair of lift tabs coupled to a top surface of the pair of guide slots extending outward from the opposing side walls of the paper tray, the pair of lift tabs raise the stack of paper.

2. The easy swap paper lift according to claim 1, wherein the easy swap paper lift further comprises:
a lifting spring coupled to a bottom surface of the rigid surface to force the rigid surface upward exposing the stack of paper within the paper for removal.

3. The easy swap paper lift according to claim 2, wherein one of the pair of lift tabs engage a restraining clip coupled to one of the side walls for restraining the easy swap paper lift in a lowered position.

4. The easy swap paper lift according to claim 2, wherein the easy swap paper lift further comprises a plurality of lifting springs coupled to a bottom surface of the rigid surface.

5. The easy swap paper lift according to claim 1, wherein the easy swap paper lift further comprises:
a restraining spring coupled to a front edge of the rigid surface and a bottom surface of the paper tray to force the rigid surface downward when the lift tabs are not lifted upward to exposing the stack of paper within the paper for removal.

6. The easy swap paper lift according to claim 5, wherein the rigid surface pivots about the connection with the pair of side edges as the rear edge of the rigid surface moves up and down as the pair of side edges slide up and down within the pair of guide slots.

7. The easy swap paper lift according to claim 6, wherein the front edge of the rigid surface comprises a pair of sliding tabs on opposing sides of the rigid surface that engage sliding guide slots within the bottom surface of the paper tray.

8. The easy swap paper lift according to claim 1, wherein the rigid surface extends under the stack of paper perpendicular to the pair of guide slots.

9. The easy swap paper lift according to claim 1, wherein the easy swap paper lift engages legal size printer paper.

10. The easy swap paper lift according to claim 1, wherein the easy swap paper lift engages letter size printer paper.
